(19) United States
(12) Patent Application Publication
(10) Pub. No.: US 2025/0382036 A1
(43) Pub. Date: Dec. 18, 2025

(54) Lightweight High Inertia Stabilizer Device for Floating Platforms

(71) Applicant: Kazuioshi Minami, Houston, TX (US)

(72) Inventor: Kazuioshi Minami, Houston, TX (US)

(21) Appl. No.: 19/073,216

(22) Filed: Mar. 7, 2025

Related U.S. Application Data
(60) Provisional application No. 63/660,733, filed on Jun. 17, 2024.

(51) Int. Cl. B63B 39/03; B63B 21/20

(52) U.S. Cl. CPC B63B 39/03; B63B 21/20

(57) ABSTRACT

A lightweight high inertia stabilizer device is provided that may be coupled to any floating vessel to increase its stability against forces of waves and winds acting on its exposed surfaces. Optionally, the device may include a midwater stabilizer tank coupled to a host vessel that may have a tank ballast cavity that may be filled or emptied with water ballast thereby lowering the position of the midwater stabilizer tank in a waterbody. Optionally, the device may include a lightweight high inertia stabilizer lowerable column that may be coupled to a host floating vessel. The lowerable column may have a column ballast cavity that may be filled or emptied with water ballast thereby lowering the position of the lowerable column in a waterbody. The device significantly reduces the undesired heave, pitch and roll movements of floating platforms or foundations, with small impact on their load capacity.

### CROSS REFERENCE TO RELATED APPLICATIONS

This application claims priority to and the benefit of the filing date of U.S. Provisional Application No. 63/660,733, filed on Jun. 17, 2024, entitled “Offshore Floating Wind Platforms with Lowerable Columns and High Inertia Water Tank Stabilizers”, which is hereby incorporated by reference in its entirety.

### FIELD OF THE INVENTION

This patent specification relates to the field of floating vessels, such as oil and gas floating platforms, ships, and wind floating foundations, respectively that may be used for the offshore oil and gas and wind power generation industries. More specifically, it relates to midwater devices to provide significantly more stable floating vessels, such as which may be used to host equipment and hang pipes, umbilicals and cables for both industries.

### BACKGROUND

Floating offshore vessels are widely used in the oil and gas industry, for drilling and production of subsea wells, and now are considered for offshore wind power generation. They are subject to oscillation movements caused by waves, winds, and currents known as heave, sway, surge, roll, pitch and yaw. Particularly, heave, roll and pitch movements are the most negatively impacting ones when offshore vessels are used to drill wells or to produce oil and gas, as they decrease efficiency and life span of equipment and structures and increase risk of accidents when operating or maintaining them. For offshore floating wind vessels, these negative impacts are even more significant due to their tall tower structures and heavy nacelles on their top.

In many cases, depending on the water depth and environmental conditions, use of such vessels can even become technically unfeasible due to the excessive movements or risks of accidents during severe metocean conditions.

In the past four decades oil and gas offshore engineers developed several technical solutions to seek stability and minimize movements of floating vessels in deepwater applications, such as very large vessels, with heavy ballasts, or novel naval architectures known as deep draft semi-subs, tension leg platforms, and spar type platforms. The drawback of these solutions is their increased sizes and complexities, and, thus, additional costs associated. However, the resource rich oil and gas offshore industry was able to cope with the added costs and floating units flourished worldwide.

The floating offshore wind electricity generation industry on the other hand, herein simply stated as offshore floating wind, is relatively newborn from the late 2010's, and it is still technically evolving. Not many large commercial applications have been implemented to date due to their higher generated energy cost compared to other sources. Many of the floating units used so far were based on the mature offshore oil and gas industry platforms, such as moored semi-submersible, tension leg semi-submersible, and spar platforms. Due to their construction and installation characteristics, and the necessity of extremely stable floater to support the large size and height of the wind generator structures, they frequently present very high and prohibitive costs, yielding to marginal or uneconomic projects.

To cope with the sea waves and winds such host floating platforms for floating winds, also interchangeably known as floating foundations, need to be very stable to operate efficiently and safely. To provide the necessary stability, engineering solutions tend to yield oversized floating units with heavy ballast, usually with tension or taut legs mooring, or the use of tall spar type units. The latest presents the additional drawback of only being applicable in deep sea in niche geographical areas, due to their long vertical structures. They must be in vertical and deep draft position to allow proper installation of the generator assembly on their top in protected seas.

Floating vessels based on above-described concepts with their main cargo of tall tower and generator on top, except for spar type units, often are not statically stable enough, which prevents them from being safely transported to their final locations. As a result, they may require final mating of tall tower and generator assemblies with their long blades to be done at open sea by tall and heavy lifting service vessels. These vessels are not so easily available worldwide. Even then, installation is only possible on calm weather days and after most mooring lines are connected and tensioned, to assure minimal movements during such stages. Thus, they also require sturdy sea floor foundations and mooring lines as well. All the described drawbacks cause the costs of the projects to frequently become unbearable or even technically infeasible.

Therefore, a need exists for a more cost-effective and simple engineering solution to reduce movements of floating vessels, not only for the offshore oil and gas industry but also for the infant offshore floating wind power generation industry, and other marine industries.

### BRIEF SUMMARY OF THE INVENTION

A lightweight high inertia stabilizer device for floating platforms is provided that may be coupled to any floating vessel to increase its stability against forces of waves and winds acting on its exposed surfaces. The device significantly reduces the undesired heave, pitch and roll movements of floating platforms or floating foundations, with small impact on their load capacity.

The forces of waves and winds act unevenly on different parts of the vessel causing uneven accelerations of such parts and, thus, creating oscillation movements. To decrease accelerations, as per the physics law, one must either decrease the acting forces or increase the mass they are moving. Decreasing wave and wind forces is not feasible and one needs to increase mass to achieve lower accelerations and movements. The device preferably uses large water tanks hanging submerged from the vessel as the added inertial mass, herein referred to as midwater stabilizer tanks. The higher the added mass, the lower the acceleration will be. The use of sea water as the main added mass in the tanks results in almost weightless bodies when submerged and, thus, they will exert a little load on the host vessels.

Preferably, a lightweight high inertia stabilizer device for floating platforms may be positioned in a water body and coupled to a host floating vessel on the water body. In typical embodiments, the device may include a midwater stabilizer tank having a tank ballast cavity. The tank ballast cavity may be configured to receive water from the water body, and water received within the tank ballast cavity may function as an added inertial mass to the device. A tank injection tube may be coupled to the midwater stabilizer tank, and the tank injection tube may be in communication with the tank ballast cavity. The tank injection tube may be configured to alternatively inject a compressed gas and water from the water body into the tank ballast cavity through a tank umbilical line that is in communication with the host floating vessel. A tank return tube may be coupled to the midwater stabilizer tank, and the tank return tube may be in communication with the tank ballast cavity. The tank return tube may be configured to empty at least a portion of the water ballast from the tank ballast cavity when a compressed gas is injected into the tank ballast cavity via the tank injection tube. Optionally, water ballast can be emptied by pumps or any other common means. Increasing the water ballast in the tank ballast cavity may result in the midwater stabilizer tank being positioned relatively deeper in the water column of the water body and the increased water ballast yielding a high inertia mass to decrease accelerations of the host floating vessel, and wherein decreasing the water ballast in the tank ballast cavity may result in the midwater stabilizer tank being positioned relatively shallower in the water column of the water body. Preferably, when the tank ballast cavity is filled with water ballast, the midwater stabilizer tank may be positioned midwater (in the water column below the surface of the water body) far from the influence of wave and wind actions and with enough seawater ballast inertial mass within to decrease substantially the accelerations caused by the wave and wind forces acting on the host floating vessel.

In some embodiments, the device may be configured as lightweight high inertia stabilizer lowerable column having a column ballast cavity, and the column ballast cavity may be configured to receive water from the water body. Water received within the column ballast cavity functions as a water ballast for the lowerable column, and the lowerable column may be movably coupled to the host floating vessel and movable between a raised position and a lowered position. A column injection tube may be coupled to the lowerable column, and the column injection tube may be in communication with the column ballast cavity. The column injection tube may be configured to alternatively inject a compressed gas and water from the water body into the column ballast cavity through a column umbilical line that is in communication with the host floating vessel. A column return tube may be coupled to the lowerable column, and the column return tube may be in communication with the column ballast cavity. The column return tube may be configured to empty at least a portion of the water ballast from the column ballast cavity when a compressed gas is injected into the column ballast cavity via the column injection tube. Optionally, water ballast can be emptied by pumps or any other common means. Increasing the water ballast in the column ballast cavity preferably results in the lightweight high inertia stabilizer lowerable column being moved towards the lowered position so that the lightweight high inertia stabilizer lowerable column is relatively more submerged in the water body and the increased water ballast yielding a high inertia mass to decrease accelerations of the host floating vessel. Decreasing the water ballast in the column ballast cavity preferably results in the lightweight high inertia stabilizer lowerable column being moved towards the raised position by the buoyance force and being relatively less submerged in the water body. Optionally, a midwater stabilizer tank may be coupled to the lower part of a lightweight high inertia stabilizer lowerable column to further increase inertial mass to be moved by wave and wind forces.

The midwater stabilizer tanks and/or lightweight high inertia stabilizer lowerable columns may be coupled to any floating vessel, such as those used in the offshore oil industry or the new offshore wind power industry. An example application for the latest, a new concept of floating foundations for offshore floating wind, herein referred to as floating wind platform with lowerable column stabilizer device is presented. Its oscillation acceleration will be inversely proportional to the added mass of the stabilizer tanks and lightweight high inertia stabilizer lowerable columns. Consequently, they are much more stable than the industry's accepted foundations. In addition, they can tackle the issues of constructability in near shore shallow waters and adequately deal with the operating inclination angle of the system under the horizontal forces acting on the wind generator blades and tower.

The midwater stabilizer tanks and/or lowerable columns may be coupled to floating platforms used in offshore oil and gas and wind power generation industries to provide added mass to be accelerated by wave and wind forces to significantly reduce their oscillation movements.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view diagram of an example of a lightweight high inertia stabilizer device having a midwater stabilizer tank according to various embodiments described herein.

FIG. 2 illustrates a sectional, elevation diagram of an example midwater stabilizer tank of a lightweight high inertia stabilizer device to various embodiments described herein.

FIG. 3 shows a perspective view diagram of an example midwater stabilizer tank of a lightweight high inertia stabilizer device coupled to a floating production storage and offloading ship according to various embodiments described herein.

FIG. 4 depicts a perspective view diagram of an example midwater stabilizer tank of a lightweight high inertia stabilizer device to a floating foundation commonly, exemplified herein with a semi-sub type floating foundation, used in the offshore wind power generation industry according to various embodiments described herein.

FIG. 5 illustrates a perspective view diagram of another example of a lightweight high inertia stabilizer device comprising a lightweight high inertia stabilizer lowerable column having a stable floating foundation that a generator tower and wind turbine may be coupled to according to various embodiments described herein.

FIG. 6 shows an elevation view diagram of the example lightweight high inertia stabilizer device comprising a lightweight high inertia stabilizer lowerable column of FIG. 5, having a stable floating foundation that a generator tower and wind turbine may be coupled to.

FIG. 7 depicts a sectional elevation diagram of an example lightweight high inertia stabilizer lowerable column, in a raised position, of another example of a lightweight high inertia stabilizer device according to various embodiments described herein.

FIG. 8 illustrates a sectional elevation diagram of an example lightweight high inertia stabilizer lowerable column, in a lowered position, of another example of a lightweight high inertia stabilizer device according to various embodiments described herein.

FIG. 9 shows a perspective view diagram of a further example of a lightweight high inertia stabilizer device having a stable floating foundation that a generator tower and wind turbine may be coupled to according to various embodiments described herein.

FIG. 10 depicts an elevation view diagram of the example lightweight high inertia stabilizer device of FIG. 9, having a stable floating foundation that a generator tower and wind turbine may be coupled to.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

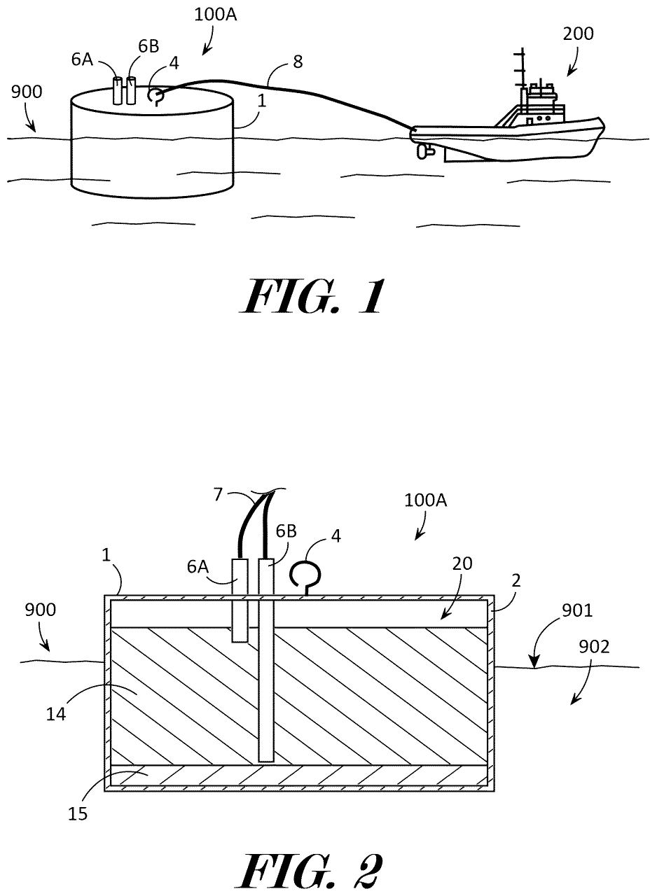

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 20% of the specified number. Additionally, as used in this application, the term “substantially” means that the actual value is within about 10% of the actual desired value, more preferably within about 5% of the actual desired value and even more preferably within about 1% of the actual desired value of any variable, element or limit set forth herein.

A new lightweight high inertia stabilizer device is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

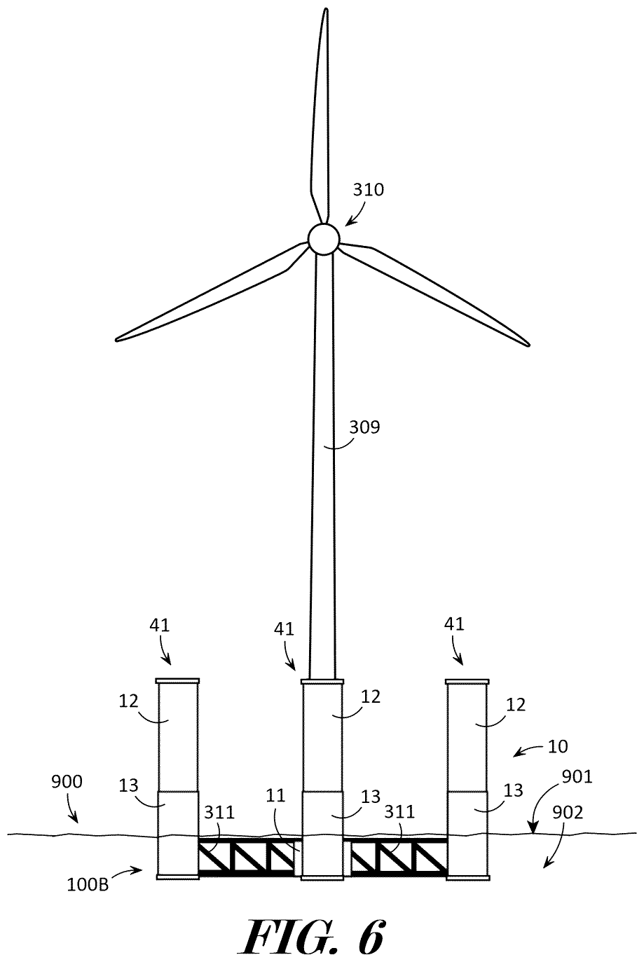

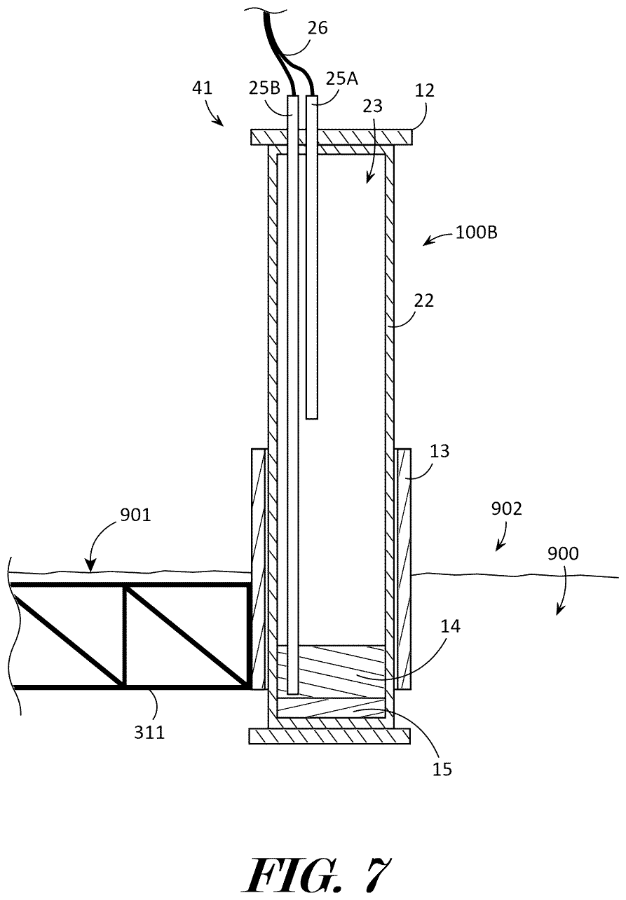

The present invention will now be described by examples and through referencing the appended figures representing preferred and alternative embodiments. FIGS. 1-10 illustrate examples of a lightweight high inertia stabilizer device 100A, 100B (“the device”), according to various embodiments.

In some embodiments, and as shown in FIGS. 1 and 2, the device 100A may comprise a midwater lightweight high inertia stabilizer water tank (also herein simply referred as “midwater stabilizer tank”) 1. In preferred embodiments, a midwater stabilizer tank 1 may comprise a large watertight vessel of any shape (e.g., cylindrical shaped, triangular prism shaped, rectangular prism shaped, etc.) with one or more tank walls 2 that may be coupled together to form a substantially watertight structure. The midwater stabilizer tank 1 may comprise one or more tank ballast cavities 20 that optionally may be bounded by the one or more walls 2. Tank ballast cavities 20 may be configured in any size and shape so as to be able to hold or contain a volume of water (water ballast 14), such as seawater, freshwater (e.g., lake water if the device 100A, 100B, is used on a lake or other freshwater), etc., that may be pumped into or removed from the tank ballast cavities 20. Preferably, tank walls 2 may be made of steel or combination of steel structure and watertight linens or plates, and may form one or more tank ballast cavities 20 to be fully or partially filled with water from a water body 900 that the midwater stabilizer tank 1 is in contact with.

Preferably, one or more connectors 4 may be coupled to a tank wall 2, such as a top or upper tank wall 2. A connector 4 may comprise a hook, eye, or any other coupling device commonly used in a marine environment to couple a line, chain, cable, etc. to a structure. In some embodiments, a host floating vessel may comprise any floating oil and gas platform, herein illustrated with a production storage and offloading ship 301, and the connector 4 may be coupled to the midwater stabilizer tank 1 and to the floating production storage and offloading ship 301. In some embodiments, a host floating vessel may comprise a floating foundation, exemplified herein with a semi-sub type floating foundation 302, that may be coupled to a wind turbine 310, and the connector 4 may be coupled to the midwater stabilizer tank 1 and to the semi-sub type floating foundation 302. In some embodiments, the host floating vessel may comprise a floating oil and gas production platform, and a connector 4 may be coupled to the midwater stabilizer tank 1 and to the floating oil and gas production platform.

Optionally, the device 100A, 100B, may comprise one or more solid ballasts 15 which may be coupled to a lower tank wall 2 and/or disposed in a tank ballast cavity 20, preferably at its bottom, of a midwater stabilizer tank 1. Solid ballast 15 may be necessary in a midwater stabilizer tank 1 to assure that its hanging cable 8 of device 100A is always fully tensioned during operation to avoid its tangling and damaging itself. Depending on the tare weight of the midwater stabilizer tank 1, especially if made of metal, solid ballast 15 is likely not necessary for certain applications. Solid ballast 15 may also be necessary in lightweight high inertia stabilizer lowerable column 12 to set proper working draft and desired verticality of the host vessel. Solid ballast 15 may comprise metal, concrete, stone, or any other material commonly used for ballast functions.

Tank internal tubes 6A, 6B, may comprise one or more tank injection tubes 6A and tank return tubes 6B, and may be used to control the amount of water ballast 14 in ballast cavities 20 and the resulting wet weight of the midwater stabilizer tank 1 when fully or partially submerged in a water body 901. Water ballast 14 (optionally sourced from the water body 900 that the midwater stabilizer tank 1 is disposed in, optionally chemically treated water sourced from an onshore base to prevent corrosion from within and this water can be overboarded to the water body safely or removed to its base, etc.), and other materials such as compressed air or inert gas, may be added to ballast cavities 20 through tank injection tubes 6A (preferably steel tubes or hoses, conduits, etc.) from tank umbilical lines 7, such as which may be connected to a floating vessel 200, 301, 302, that the device 100A, is coupled to. Water ballast 14 may be removed from tank ballast cavities 20 through tank return tubes 6B by injecting compressed air or inert gas through tank injection tubes 6A to fully or substantially displace the water ballast 14 out of tank ballast cavities 20 through an outwards or tank return tube 6B, such as which may be connected to a host floating vessel 301, 302 or towing vessel 200 or which may empty into the water body 900. Optionally, water ballast can be emptied by pumps. As more water ballast 14 is added in a tank ballast cavity 20, the midwater stabilizer tank 1 may be relatively more submerged in the water body 900 that it is positioned in, including being fully submerged below the surface 901 of the water body 900. Conversely, as water ballast 14 is removed from a tank ballast cavity 20, the midwater stabilizer tank 1 may be relatively less submerged in the water body 900 that it is positioned in, so that relatively more of the midwater stabilizer tank 1 is above the surface 901 of the water body 900.

By adding water ballast 14 in tank ballast cavities 20 via tank injection tubes 6A, a midwater stabilizer tank 1 may be brought to near zero wet weight to facilitate its handling by light service vessels as the shown towing vessel 200 during its connection to the host floating vessel 301, 302, and smooth lowering to the desired depth, without undesirable impacts to the host floating vessel 301, 302. Tank injection tubes 6A may also be used to empty at least a portion (e.g., fully or partially) of the water ballast 14 from tank ballast cavities 20 in a midwater stabilizer tank 1, such as when its removal to shore for inspection, maintenance or final disposal become necessary, by injecting compressed air or inert gas through tank injection tubes 6A to fully or partially displace the water ballast 14 out of tank ballast cavities 20 through an outwards or tank return tube 6B.

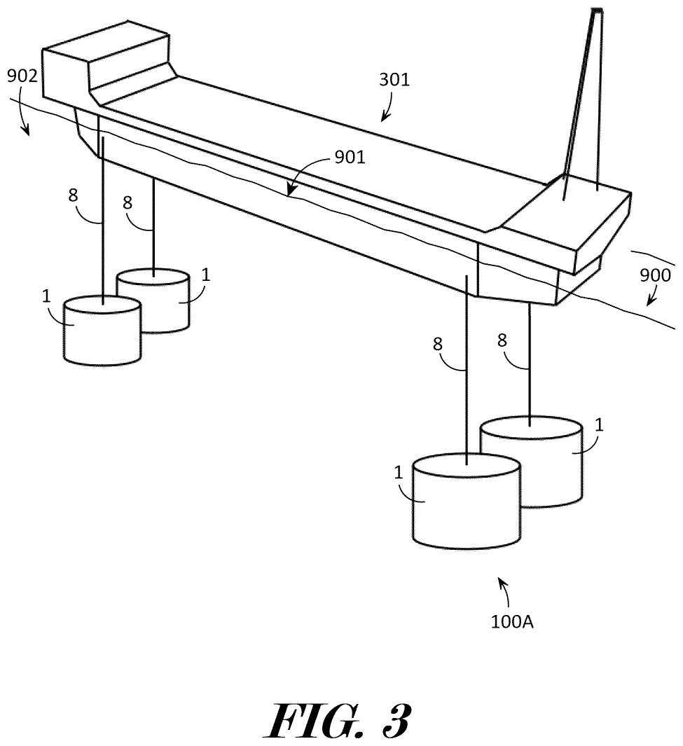

In preferred embodiments, the device 100A, 100B, may comprise one or more midwater stabilizer tanks 1 which may be hung or positioned midwater from specific outermost positions of floating vessels 301, 302, and may be supported and coupled to the floating units by cables 8 as shown in FIGS. 3, 4, 9, 10. Cables 8 may comprise chains, metal cables, ropes, etc. The high inertia and damping action of the midwater stabilizer tanks 1 significantly change the floating body dynamics caused by the ocean waves and winds, and thus significantly reduce movements of the host floating vessels 301, 302, that are host platforms for the device 100A. Another benefit is that the midwater stabilizer tanks 1 of the device 100A, can decrease the natural oscillating frequency of the host floating vessels 301, 302, that the device 100A, is coupled to and move the host floating vessels 301, 302, away from catastrophic resonance phenomenon.

In preferred embodiments, hanging cables 8 of the device 100A, may be required to be tensioned at all times to avoid damaging themselves by tangling during the downward movements of the host floating vessel 301, 302, that the device 100A, is coupled to. If necessary, solid ballast 15 may be added, preferably to the bottom, of the midwater stabilizer tanks 1 to assure minimum traction of cables 8 for all metocean conditions. If the midwater stabilizer tanks 1 are steel made, it is likely that their self-weight may be sufficient to meet this requirement.

Offshore installation by coupling the device 100A, 100B, to a floating vessel or host floating vessel 301, 302, 10, requires careful handling of different parts of hardware that compose the device 100A, 100B, 10, to avoid damage or even severe accidents. To tackle this and facilitate installation and positioning of the midwater stabilizer tanks 1, the device 100A, 100B, may comprise a means to fill and/or remove water ballast 14 from the midwater stabilizer tanks 1. In preferred embodiments, a means to fill and/or remove water ballast 14 from a midwater stabilizer tank 1 may comprise two tank internal tubes 6A, 6B, that may be coupled to the midwater stabilizer tank 1 and installed to be in communication with one or more tank ballast cavities 20 of the midwater stabilizer tank 1. Preferably, the device 100A, may comprise at least one tank injection tube 6A configured for injection of water (such as water from water body 900 that the midwater stabilizer tank 1 is disposed in), compressed air or inert gas, etc., into a tank ballast cavity 20, and at least one tank return tube 6B configured for the return of water ballast 14 into the water body 900 that the device 100A, is disposed in. A tank return tube 6B should extend to or proximate to the bottom of the tank ballast cavity 20 and/or extend to the top of the solid ballast 15 to allow substantially complete removal of water ballast 14 through outward or tank return tube 6B when pushed by compressed air or inert gas injected into tank ballast cavity 20 through inwards or tank injection tube 6A. Optionally, water ballast can be emptied by pumps or any other common means. This feature allows fine control of wet weight of the midwater stabilizer tanks 1 yielding easy handling done by light service towing vessel 200, with little or no impact to the host floating platform or foundation of a floating host vessel 301, 302, 10.

FIG. 3 illustrates an application of a device 100A having four midwater stabilizer tanks 1 coupled to and submerged below a traditional offshore oil and gas production platforms, such as the shown floating production storage and offloading ship 301, also known as FPSO in the offshore petroleum industry. The midwater stabilizer tanks 1 may be coupled to the traditional offshore oil and gas production platforms, such as the shown floating production storage and offloading ship 301 via hanging cables 8, and preferably with tank umbilical lines 7 coupled to the traditional floating production storage and offloading ship 301 and to tank internal tubes 6A, 6B. It should be understood that midwater stabilizer tanks 1 may be coupled to any floating vessel that needs increased stability, including to shape or configuration of oil and gas production platform and it is not limited to use with an FPSO. The resulting increased stability of the production platform or floating production storage and offloading ship 301 that is provided by midwater stabilizer tanks 1 having a volume of water ballast 14 contained in their tank ballast cavities 20 so that the midwater stabilizer tanks 1 are positioned in the water column 902 of the water body 900 below the floating production storage and offloading ship 301 significantly improves performance of process equipment and increase life span of structures, equipment, hung pipes, cables and umbilicals of the floating production storage and offloading ship 301. It may even allow substitution of commonly used flexible pipe risers, that are complex and expensive, by much more resistant and cheaper steel catenary risers.

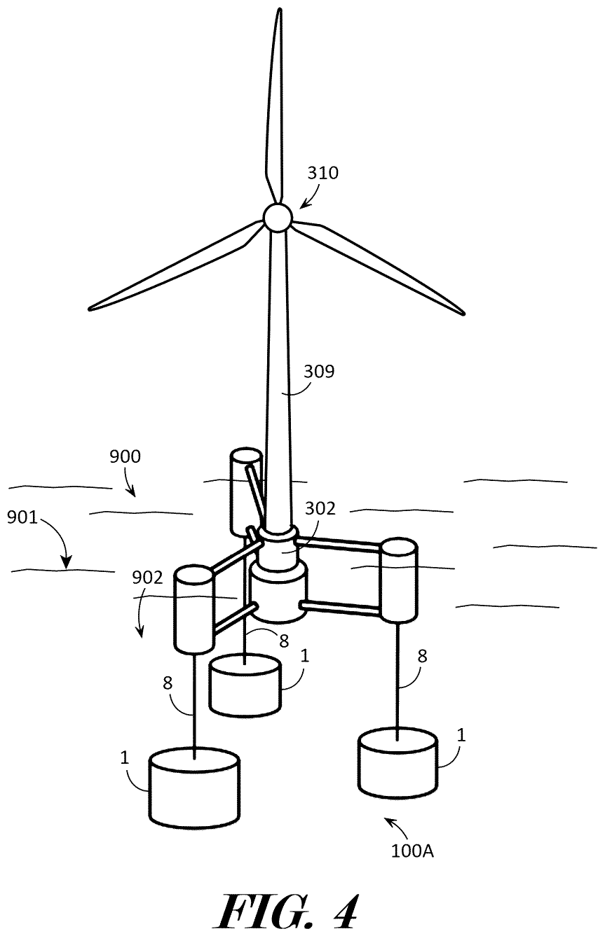

FIG. 4 illustrates an application of a device 100A having three midwater stabilizer tanks 1 coupled to a three-column floating foundation, exemplified herein with a semi-sub type floating foundation 302 having a wind turbine 310 coupled thereto, currently broadly utilized by the offshore wind power industry. The resulting increased stability of the semi-sub type floating foundation 302 and wind turbine 310 that is provided by midwater stabilizer tanks 1 having a volume of water ballast 14 contained in their tank ballast cavities 20 so that the midwater stabilizer tanks 1 are positioned in the water column 902 of the water body 900 below the semi-sub type floating foundation 302 significantly improves performance and service longevity of the equipment. The midwater stabilizer tanks 1 may be coupled to the semi-sub type floating foundation 302 via hanging cables 8, and preferably with tank umbilical lines 7 coupled to the semi-sub type floating foundation 302 and to tank internal tubes 6A, 6B. Without the device 100A, semi-sub type floating foundation 302 will suffer larger movements implying more frequent corrective maintenance for the motion sensitive tower 309 and generator assembly of the wind turbine 310. The larger movements make more difficult maintenance work to be done offshore, and a few can only be done safely onshore, which can significantly hurt the economics of the offshore floating wind industry. By simply coupling the midwater stabilizer tanks 1 of the device 100A of the present invention directly to industry accepted semi-sub type floating foundations 302, one will be able to increase time intervals of corrective maintenance and, thus, cut costs. The increased stability will also provide healthier and safer working conditions for human intervention to be done offshore.

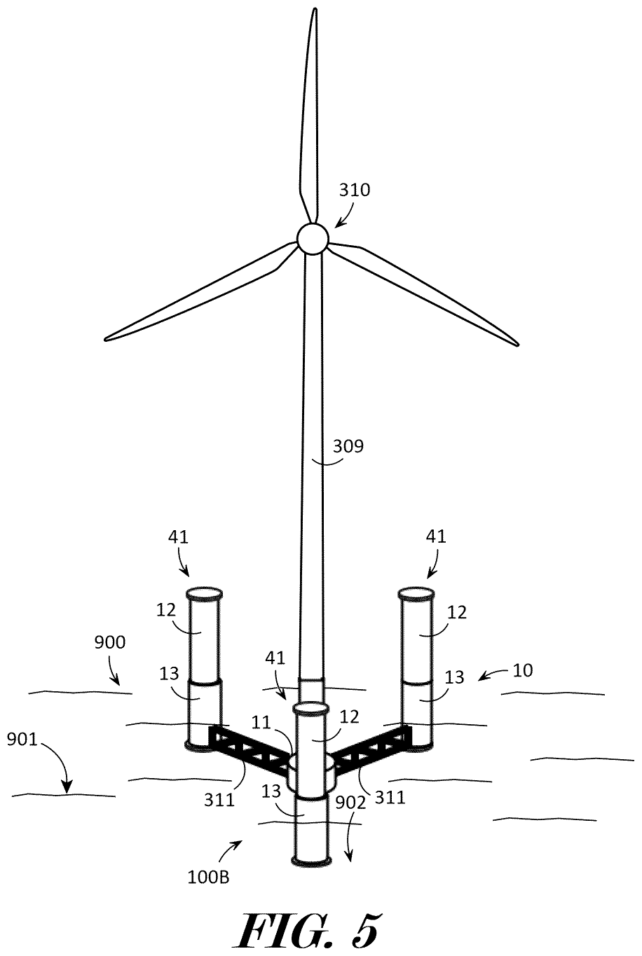

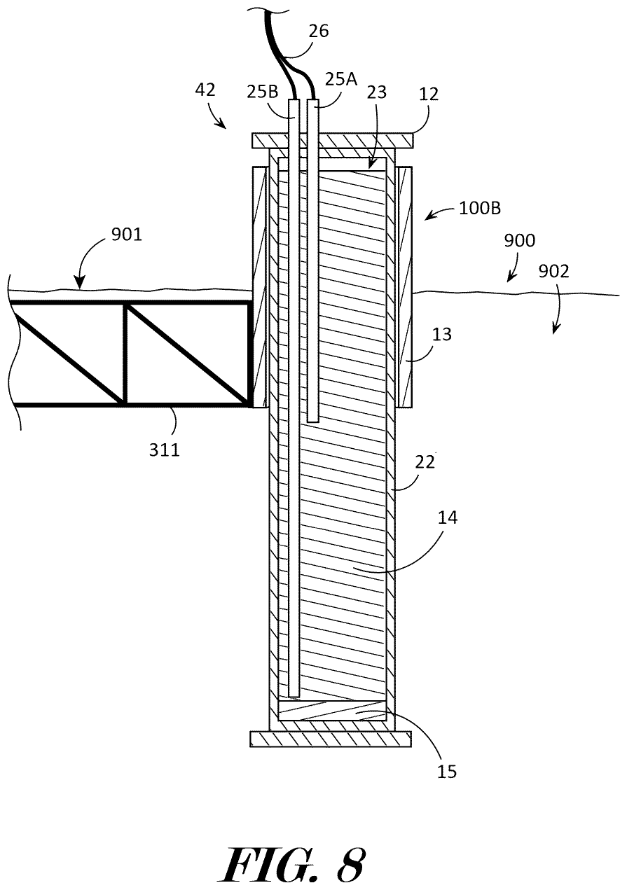

FIGS. 5-10 show embodiments of the device 100A, 100B, that may provide a novel semi-submersible offshore wind platform or foundation. In some embodiments, the stable floating foundation 10 that may be coupled to a wind turbine 310 for use with Offshore Floating Wind Power Generators, may comprise a device 100B. In preferred embodiments, a stable floating foundation 10 may comprise a central buoy 11 with structural framework 311 and a multitude of lightweight high inertia stabilizer lowerable columns 12 that may be coupled to the generator tower 309 of a wind turbine 310 via structural framework 311 or other coupling device or structure. The lightweight high inertia stabilizer lowerable columns 12 may be movably coupled to the structural framework 311 so that the lightweight high inertia stabilizer lowerable columns 12 may be movable between a raised position 41 (FIGS. 5-7) and a lowered position 42 (FIGS. 8-10). When lightweight high inertia stabilizer lowerable columns 12 are in raised position 41, the stable floating foundation 10 has its lowest draft allowing afloat tow out from shallow construction sites. When lightweight high inertia stabilizer lowerable columns 12 are in lowered position 42, the floating behavior of the stable floating foundation 10 platform may be changed from conventional semi-submersible to more stable deep-draft semi-submersible. Additionally, lightweight high inertia stabilizer lowerable columns 12 in the lowered position 42 act as long momentum arms to increase weight action of ballast(s) 14, 15, contained in the lightweight high inertia stabilizer lowerable columns 12 to enhance static stability of the stable floating foundation 10, and to minimize its wind turbine 310 and generator tower 309 inclination from vertical when acted on by the wind. In some embodiments, a stable floating foundation 10 may comprise three lightweight high inertia stabilizer lowerable columns 12 in a generally triangular arrangement coupled to a generally triangular stable floating foundation 10. However, a stable floating foundation 10 may be configured in any shape and size and have three, four, five, or more lightweight high inertia stabilizer lowerable columns 12 coupled to it.

In preferred embodiments, and similar to a midwater stabilizer tank 1, a lightweight high inertia stabilizer lowerable column 12 may comprise a large watertight vessel of any shape (e.g., cylindrical shaped, triangular prism shaped, rectangular prism shaped, etc.) with one or more column walls 22 that may be coupled together to form a substantially watertight structure. The lightweight high inertia stabilizer lowerable column 12 may comprise one or more column ballast cavities 23 that optionally may be bounded by the one or more column walls 22. Column ballast cavities 23 may be configured in any size and shape so as to be able to hold or contain a volume of water, such as seawater, freshwater (e.g., lake water if the device 100A, 100B, is used on a lake or other freshwater), etc., that may be pumped into the column ballast cavities 23 from the water body 900. Preferably, walls 22 may be made of steel or combination of steel structure and watertight linens or plates, and may form one or more column ballast cavities 23 to be fully or partially filled with water from a water body 900 that may then function as water ballast 14.

Optionally, the lightweight high inertia stabilizer lowerable column 12 may comprise one or more solid ballasts 15 which may be coupled to a column lower wall 22 and/or disposed in a column ballast cavity 23, preferably at its bottom. Depending on the tare weight of the lightweight high inertia stabilizer lowerable column 12, especially if made of metal, solid ballast 15 may not be necessary for certain applications. Solid ballast 15 may comprise metal, concrete, stone, or any other material commonly used for ballast functions.

Optionally, the device 100B may comprise one or more column internal tubes 25A, 25B, which may be in communication with the one or more column ballast cavities 23 and in communication with a host floating vessel (e.g., stable floating foundation 10) that the device 100B is coupled to. Column internal tubes 25A, 25B, may be used to control the amount of water ballast 14 in column ballast cavities 23 and the resulting wet weight of the lightweight high inertia stabilizer lowerable columns 12 when fully or partially submerged in a water body 901. Column internal tubes 25A, 25B, may provide fluid communication between the stable floating foundation 10 and the column ballast cavities 23 to allow column ballast cavities 23 to be filled or emptied of water ballast 14 remotely through column umbilical lines 26 of stable floating foundation 10, that the device 100B is coupled to. Column internal tubes 25A, 25B, may comprise one or more column injection tubes 25A and column return tubes 25B, and may be used to control the amount of water ballast 14 in column ballast cavities 23 and the resulting wet weight of the lightweight high inertia stabilizer lowerable column 12 when fully or partially submerged. Water ballast 14 (optionally sourced from the water body 900 that the lightweight high inertia stabilizer lowerable column 12 is disposed in or optionally sourced from any other suitable source) and other materials such as compressed air or inert gas, may be added to column ballast cavities 23 through injection tubes 25A or injection conduits from column umbilical lines 26. Water ballast 14 may be removed from column ballast cavities 23 through return tubes 25B or return conduits by injecting compressed air or inert gas through injection tubes 25A to fully displace the water ballast 14 out of column ballast cavities 23 through an outwards or return tube 25B. Optionally, water ballast 14 can be emptied by pumps or any other common means.

By adding water ballast 14 in column ballast cavities 23 via injection tubes 25A (preferably steel hoses, conduits, etc.), a lightweight high inertia stabilizer lowerable column 12 may be fully or mostly submerged to the desired depth. Column injection tubes 25A may also be used to empty at least a portion (e.g., fully or partially) of the water ballast 14 from column ballast cavities 23 in a lightweight high inertia stabilizer lowerable column 12, such as when its removal to shore for inspection, maintenance or final disposal become necessary, by injecting compressed air or inert gas through column injection tubes 25A to fully displace the water ballast 14 out of column ballast cavities 23 through an outwards or column return tube 25B (preferably flexible or rigid hoses, conduits, etc.). Optionally, water ballast 14 can be emptied by pumps or any other common means.

A lightweight high inertia stabilizer lowerable column 12 may be movably coupled to a sliding sleeve 13, sliding rails (not shown), or other movable coupling that may be in turn coupled to the structural framework 311 of stable floating foundation 10. In preferred embodiments, a lightweight high inertia stabilizer lowerable column 12 may be movably coupled to a sliding sleeve 13 to freely move vertically within the sliding sleeve 13 or on sliding rails (not shown) attached to the outermost parts of the floating foundation. In preferred embodiments, a sliding sleeve 13 may be coupled to the host floating foundation 10, and a lightweight high inertia stabilizer lowerable column 12 may be movably coupled to the sliding sleeve 13 to freely move vertically within the sliding sleeve 13 between the raised position 41 and the lowered position 42. In some embodiments, a lightweight high inertia stabilizer lowerable column 12 may freely move up and down between the raised 41 and lowered 42 positions depending on the weight of the water ballast 14 put within column ballast cavities 23 via column injection tubes 25A. Once the lightweight high inertia stabilizer lowerable columns 12 are lowered to the desired positions, they shall be firmly locked in place.

FIGS. 5-7 show an example of a stable floating foundation 10 for offshore floating wind power generators with their attached lightweight high inertia stabilizer lowerable columns 12 in their raised position 41. In the up or raised position 41, the lightweight high inertia stabilizer lowerable columns 12 may be majoritively unsubmerged in the water body 900 and may act mainly as auxiliary floaters to provide the necessary stability to prevent the semi-sub type floating foundation 10 from tipping over during transportation to its final location.

The lightweight high inertia stabilizer lowerable columns 12 have similar working principles to the midwater stabilizer tanks 1. The lightweight high inertia stabilizer lowerable columns 12 are configured to float on their own but are preferably attached to stable floating foundation 10 and can be ballasted to the desired draft in a controlled manner. At the construction site, the lightweight high inertia stabilizer lowerable columns 12 are preferably set without the water ballast 14 to provide buoyance force to offset its dry weight at desired draft. Optionally, the lightweight high inertia stabilizer lowerable columns 12 may comprise bottom solid ballast 15. Preferably, the amount of solid ballast 15 shall be the largest possible, but small enough to have lightweight high inertia stabilizer lowerable columns' 12 free flotation draft compatible with water depth at the construction site.

In some embodiments, and as shown in FIGS. 5-10, the device 100B may comprise a stable floating foundation 10 having three or more lightweight high inertia stabilizer lowerable columns 12 that may be coupled to the generator tower 309 of a wind turbine 310 via structural framework 311 or other coupling device or structure. The lightweight high inertia stabilizer lowerable columns 12 may be movably coupled to the structural framework 311 by sliding sleeve 13 or sliding rail (not shown) so that the lightweight high inertia stabilizer lowerable columns 12 may be movable between a raised position 41 (FIGS. 5-7) and a lowered position 42 (FIGS. 8-10). In the raised position 41, preferably the majority of the lightweight high inertia stabilizer lowerable column 12 may be positioned above the surface of the water body that the device 100B is disposed in or on. In the lowered position 42, preferably the majority of the lightweight high inertia stabilizer lowerable column 12 may be positioned below the surface of the water body that the device 100B is disposed in or on. Preferably, a midwater stabilizer tank 1 may be coupled to each lightweight high inertia stabilizer lowerable column 12 via a hanging cable 8. Preferably, a lightweight high inertia stabilizer lowerable column 12 may freely move up and down between the raised 41 and lowered 42 positions depending on the weight of the water ballast 14 put within the ballast cavity 23 and/or on the net pulling forces of the midwater stabilizer tanks 1 coupled to them when their ballast cavities 20 are filled with water ballast 14. Once the lightweight high inertia stabilizer lowerable columns 12 are lowered to the desired positions, they shall be firmly locked in place.

When the lightweight high inertia stabilizer lowerable columns 12 are in the raised position 41, the stable floating foundation 10 with its generator assembly or wind turbine 310, without the midwater stabilizer tanks 1 can be safely transported to their final location by light service towing vessel 200. Before leaving the construction site, loose hanging cables 8 can be pre-installed under each lightweight high inertia stabilizer lowerable column 12. Midwater stabilizer tanks 1 can also be separate and safely towed to the final location. Upon arrival at the final location, midwater stabilizer tanks 1, kept afloat, can be easily attached to each lightweight high inertia stabilizer lowerable column 12 via cables 8. Midwater stabilizer tanks 1 can then be submerged and lowered to their final depths by controlled filling of ballast cavity 20 with water ballast 14.

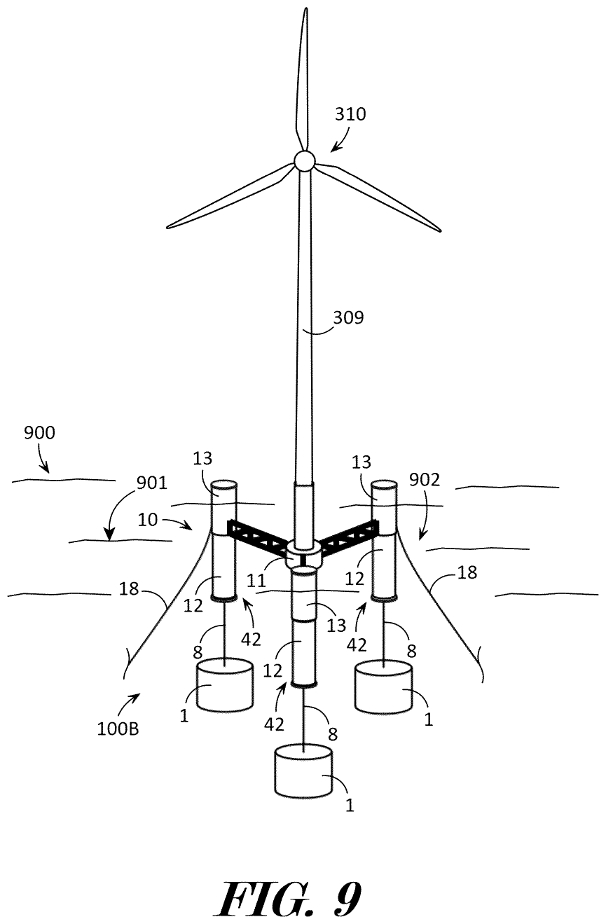

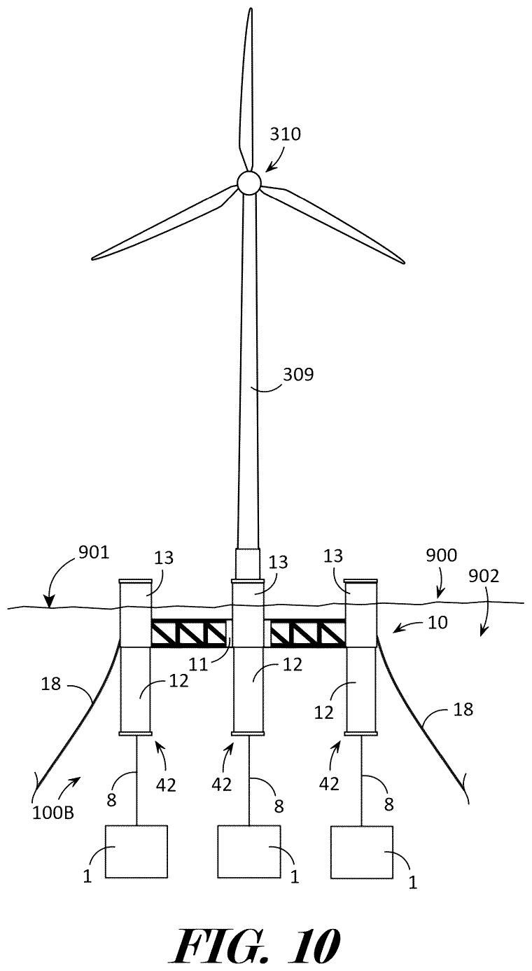

FIGS. 9 and 10 depicts an example of a device 100B, after all lightweight high inertia stabilizer lowerable columns 12 are lowered to their final depth in the lowered position 42, pulled by the wet weight of the midwater stabilizer tanks 1 and the added water ballast 14 within the lightweight high inertia stabilizer lowerable columns 12 and midwater stabilizer tanks 1. An example of possible process of hanging the midwater stabilizer tanks 1 and installation of components to be done all in synchronism at final installation site, but not limited to, is given: i) connect the loose cables 8 from the bottom of lightweight high inertia stabilizer lowerable columns 12 to the midwater stabilizer tanks 1 and unlock the first; ii) through the control tank umbilical line 7 coupled to the tank injection tubes 6A to inject water ballast 14 into tank ballast cavities 20 to ballast the midwater stabilizer tanks 1 to achieve their zero net weight in water; iii) gradually add more water ballast 14 to the midwater stabilizer tanks 1, and lower them to stretch out their hanging cables 8; iv) inject additional water ballast 14 into the midwater stabilizer tanks 1 to slowly pull down the lightweight high inertia stabilizer lowerable columns 12 to their final lowered positions 42, and lock them; v) pull in and tension mooring lines 18 to the stable floating foundation 10; vi) finally, add water ballast 14 into the column ballast cavities 23 via column umbilical lines 26 coupled to column injection tubes 25A of the lightweight high inertia stabilizer lowerable columns 12 in synchronism to achieve final working submerged depth for the stable floating foundation 10. The final step of the installation process will be to fine tune the amount of water ballasting 14 of the lightweight high inertia stabilizer lowerable columns 12 to bring their top at the desired free board height.

The added travel length of lightweight high inertia stabilizer lowerable columns 12 in the lowered position 42 brings deep draft behavior to the stable floating foundation 10 platform and augmented momentum arms to the weights of water ballast 14 and optional solid ballast 15 within and hung below them in midwater stabilizer tanks 1. This will increase overall stability of the stable floating foundation 10 or semi-sub type floating foundation 302 and decrease inclination angle of the generator tower 309 of the wind turbine 310 that result from the horizontal wind forces acting on the blades of the wind turbine 310.

The stable floating foundation 10 coupled to device 100A, 100B, of the above embodiments is much more stable than the industry accepted concepts of foundations in the offshore floating wind power industry, and can yield higher operational efficiency, with higher up time, lower maintenance costs, and safer working conditions for manned interventions at open sea.

The various teachings described above can be used either alone or in various combinations. It should be noted it is not limited to the use of the offshore oil or wind power industries, but also of all industries that require stable floating vessels to perform activities at open sea or even near shore conditions.

While some exemplary shapes and sizes have been provided for elements of the device 100A, 100B, it should be understood to one of ordinary skill in the art that the midwater stabilizer tanks 1, stable floating foundation 10, lightweight high inertia stabilizer lowerable columns 12, sliding sleeves 13, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the device 100A, 100B, may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the device 100A, 100B, may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the device 100A, 100B, may be coupled or removably connected by, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the device 100A, 100B, may be coupled by being one of connected to and integrally formed with another element of the device 100A, 100B.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A lightweight high inertia stabilizer device to be positioned in a water body and coupled to a host floating vessel on the water body, the device comprising:
a midwater stabilizer tank having a tank ballast cavity, wherein the tank ballast cavity is configured to receive water from the water body or other source, and wherein water received within the tank ballast cavity functions as a water ballast for the midwater stabilizer tank;
a tank injection tube coupled to the midwater stabilizer tank, the tank injection tube in communication with the tank ballast cavity, wherein the tank injection tube is configured to alternatively inject a compressed gas and water from the water body into the tank ballast cavity through a tank umbilical line that is in communication with the host floating vessel; and
a tank return tube coupled to the midwater stabilizer tank, the tank return tube in communication with the tank ballast cavity, and the tank return tube configured to empty at least a portion of the water ballast from the tank ballast cavity when a compressed gas is injected into the tank ballast cavity via the tank injection tube, wherein increasing the water ballast in the tank ballast cavity results in the midwater stabilizer tank being positioned relatively deeper in the water body and the increased water ballast yielding a high inertia mass to decrease accelerations of the host floating vessel, and wherein decreasing the water ballast in the tank ballast cavity results in the midwater stabilizer tank being positioned relatively shallower deeper in the water body.

2. The device of claim 1, further comprising a solid ballast.

3. The device of claim 2, wherein the solid ballast is disposed within the tank ballast cavity.

4. The device of claim 1, further comprising a connector coupled to the midwater stabilizer tank.

5. The device of claim 4, further comprising a hanging cable, wherein the hanging cable is coupled to the connector and coupled to the host floating vessel.

6. The device of claim 5, wherein when the tank ballast cavity is filled with the water ballast, the midwater stabilizer tank is positioned midwater far from the influence of wave and wind actions resulting in an inertial mass of the water ballast within the midwater stabilizer tank to decrease substantially accelerations caused by the wave and wind forces acting on the host floating vessel.

7. The device of claim 4, wherein the host floating vessel comprises a floating oil and gas production platform, and wherein the connector is coupled to the midwater stabilizer tank and to the floating oil and gas production platform.

8. The device of claim 4, wherein the host floating vessel comprises a floating foundation that is coupled to a wind turbine, and wherein the connector is coupled to the midwater stabilizer tank and to the floating foundation.

9. A lightweight high inertia stabilizer device to be positioned in a water body and coupled to a host floating vessel on the water body, the device comprising:
a lightweight high inertia stabilizer lowerable column having a column ballast cavity, wherein the column ballast cavity is configured to receive water from the water body or other source, and wherein water received within the column ballast cavity functions as a water ballast for the lightweight high inertia stabilizer lowerable column, and wherein the lightweight high inertia stabilizer lowerable column is movably coupled to the host floating vessel and movable between a raised position and a lowered position;
a column injection tube coupled to the lightweight high inertia stabilizer lowerable column, the column injection tube in communication with the column ballast cavity, wherein the column injection tube is configured to alternatively inject a compressed gas and water from the water body into the column ballast cavity through a column umbilical line that is in communication with the host floating vessel; and
a column return tube coupled to the lowerable column, the column return tube in communication with the column ballast cavity, and the column return tube configured to empty at least a portion of the water ballast from the column ballast cavity when a compressed gas is injected into the column ballast cavity via the column injection tube, wherein increasing the water ballast in the column ballast cavity results in the lightweight high inertia stabilizer lowerable column being moved towards the lowered position so that the lightweight high inertia stabilizer lowerable column is relatively more submerged in the water body and the increased water ballast yielding a high inertia mass to decrease accelerations of the host floating vessel, and wherein decreasing the water ballast in the column ballast cavity results in the lightweight high inertia stabilizer lowerable column being moved towards the raised position and being relatively less submerged in the water body.

10. The device of claim 9, further comprising a solid ballast.

11. The device of claim 10, wherein the solid ballast is disposed within the column ballast cavity.

12. The device of claim 9, further comprising a sliding sleeve that is coupled to the host floating vessel, wherein the lowerable column is movably coupled to the sliding sleeve to freely move vertically within the sliding sleeve between the raised position and the lowered position.

13. The device of claim 9, further comprising a midwater stabilizer tank, the midwater stabilizer tank comprising: a tank ballast cavity, wherein the wherein midwater stabilizer tank is coupled to the lowerable column, wherein the tank ballast cavity is configured to receive water from the water body or other source, and wherein water received within the tank ballast cavity functions as a water ballast for the midwater stabilizer tank; a tank injection tube coupled to the midwater stabilizer tank, the tank injection tube in communication with the tank ballast cavity, wherein the tank injection tube is configured to alternatively inject a compressed gas and water from the water body into the tank ballast cavity through a tank umbilical line that is in communication with the host floating vessel; and a tank return tube coupled to the midwater stabilizer tank, the tank return tube in communication with the tank ballast cavity, and the tank return tube configured to empty the water ballast from the tank ballast cavity when a compressed gas is injected into the tank ballast cavity via the tank injection tube, wherein increasing the water ballast in the tank ballast cavity results in the midwater stabilizer tank being positioned relatively deeper in the water body and the increased water ballast yielding a high inertia mass to decrease accelerations of the host floating vessel, and wherein decreasing the water ballast in the tank ballast cavity results in the midwater stabilizer tank being positioned relatively shallower in the water body.

14. The device of claim 13, further comprising a solid ballast.

15. The device of claim 14, wherein the solid ballast is disposed within the tank ballast cavity.

16. The device of claim 13, further comprising a connector coupled to the midwater stabilizer tank.

17. The device of claim 16, further comprising a hanging cable, wherein the hanging cable is coupled to the connector and to the lowerable column.

18. The device of claim 17, wherein when the tank ballast cavity is filled with the second water ballast, the midwater stabilizer tank is positioned midwater far from the influence of wave and wind actions and with enough seawater ballast inertial mass within to decrease substantially the accelerations caused by the wave and wind forces acting on the host floating vessel.
